(19) United States
(12) Patent Application Publication
(10) Pub. No.: US 2014/0282648 A1
(43) Pub. Date: Sep. 18, 2014

(54) SMART TELEVISION AND METHOD FOR BROADCASTING TV SHOW THEREFOR

(71) Applicant: HON HAI PRECISION INDUSTRY CO., LTD., New Taipei (TW)

(72) Inventors: KUAN-JUNG CHIU, New Taipei (TW); HAN-FANG TU, New Taipei (TW); MEI-JU CHEN, New Taipei (TW)

(73) Assignee: HON HAI PRECISION INDUSTRY CO., LTD., New Taipei (TW)

(21) Appl. No.: 14/210,374

(22) Filed: Mar. 13, 2014

(30) Foreign Application Priority Data
Mar. 14, 2013 (TW) 102109127

(51) Int. Cl. H04N 21/45; H04N 21/4415; H04N 21/458; H04N 21/258

(52) U.S. Cl. CPC H04N 21/4532; H04N 21/25891; H04N 21/4415; H04N 21/458
USPC 725/12

(57) ABSTRACT

A method for broadcasting TV show as used in a smart TV. The smart TV comprises a body, a facial image capturing unit and a storage unit. The storage unit stores facial images of registered users and a mapping relationship between a number of favorite TV show lists and a number of accounts. The method comprises following steps. Capturing the facial images in front of the facial image capturing unit, identifying whether the captured facial images contain one or more facial images of registered users of the smart TV and identify the number of the registered users contained in the captured facial images. In addition, controlling the smart TV to enter a broadcasting mode according to the identified users. Importing TV shows associated with the broadcasting mode of the smart TV and the favorite TV show lists. A smart TV is also provided by the present disclosure.

### BACKGROUND

1. Technical Field

The present disclosure relates to smart televisions (TVs), and particularly to a smart television and a method for broadcasting TV shows on the smart television.

2. Description of Related Art

Smart TVs supply personalized services for users because of functions that permit the users to set their own accounts, passwords, and their favorite TV shows. However, when a user wants to watch his favorite TV shows, he must manually input his account and password, which is inconvenient for the user.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is a schematic view of an embodiment of a smart TV.

FIG. 2 is a block diagram of the smart TV of FIG. 1.

FIG. 3 is a flowchart of an embodiment of a method for broadcasting TV shows on smart TVs such as the one of FIG. 1.

### DETAILED DESCRIPTION

FIGS. 1 and 2 show a smart TV 100. The smart TV 100 includes a body 10, a storage unit 20, a facial image capturing unit 30, an identification unit 40, a control unit 50 and an import unit 60. The body 10 includes a screen 11.

The storage unit 20 stores facial images of registered users of the smart TV 100 and a mapping relationship between a number of favorite TV show lists and a number of accounts of registered users. In the embodiment, each of the favorite TV show lists includes at least one favorite TV show of the associated registered user. In an alternative embodiment, the favorite TV show list also includes a broadcasting priority of each of the favorite TV shows. Take the table 1 below for example; the favorite TV show list of registered user A includes four favorite TV shows: “broken girls”, “survivor”, “how I met your mother” and “project runway”. The broadcasting priorities of these four TV shows are: the first priority is given to “broken girls”, the second priority is given to “project runway”, the third priority is given to “how I met your mother and the last priority is given to “survivor”.

TABLE 1
User A's Favorite TV Show List

| | TV show | Broadcasting priority |
|---|---|---|
| 1 | broken girls | 1 |
| 2 | project runway | 2 |
| 3 | I met your mother | 3 |
| 4 | survivor | 4 |

The facial image of each registered user is associated with his favorite TV show list. The associations are recorded in a relationship list stored in the storage unit 20. In the embodiment, the associated registered user sets the TV shows included in the favorite TV show list. In an alternative embodiment, the TV shows included in the favorite TV show list also can be automatically created by the control unit 50 of the smart TV 100 according to the watch history of the associated registered user.

The facial image capturing unit 30 is configured to capturing the facial images in front of the facial image capturing unit 30. In the embodiment, the facial image capturing unit 30 captures the facial images after the smart TV 100 completes the initialization of the system of the smart TV 100 and before a registered user logins his account on the smart TV 100. In another embodiment, the facial image capturing unit 30 captures the facial images when the smart TV 100 receives a command to switch between user accounts. The facial image capturing unit 30 is an image capturing device, such as a camera. In the embodiment, the facial image capturing unit 30 is equipped on the body 10.

The identification unit 40 is configured to identify whether the facial images captured by the facial image capturing unit 30 contains one or more facial images of the registered users of the smart TV 100. If yes, the identification unit 40 is also configured to identify the number of the registered users contained in the captured facial images. The control unit 50 controls the smart TV 100 to enter a broadcasting mode according to the number of the identified registered users. In the embodiment, the broadcasting mode of the smart TV 100 includes a personal broadcasting mode, a home broadcasting mode and a normal broadcasting mode. Under the personal broadcasting mode, the smart TV 100 broadcasts a TV show preferred by the identified registered user according to the favorite TV show list of the identified registered user. Under the home broadcasting mode, the smart TV 100 broadcasts a TV show preferred by the identified registered users according to the favorite TV show lists of the identified registered users. Under the normal broadcasting mode, the smart TV 100 broadcasts a TV show that is not according to the favorite TV show lists of the registered user.

The control mode 52 controls the smart TV 100 to enter the personal broadcasting mode when the identification unit 40 identifies only one registered user. The control unit 50 controls the smart TV 100 to enter the home broadcasting mode when the identification unit 40. The control module controls the smart TV 100 to enter the normal broadcasting mode when the identification unit 40 identifies none registered user.

The import unit 60 is configured to import TV shows associated with the mode of the smart TV 100 and the favorite TV show list(s) corresponding to the identified registered user(s). When the smart TV 100 enters the personal broadcasting mode, the import unit 60 imports TV shows preferred by the identified registered user , that is to say, the import unit 60 imports the TV shows according to the favorite TV show list of the identified registered user whose facial image is captured by the facial image capturing unit 30. When the smart TV 100 enters the home broadcasting mode, the import unit 60 imports the TV shows preferred by the identified registered users, that is to say, the import unit 60 imports the TV shows according to the favorite TV show lists of the identified registered users whose facial images are captured by the facial image capturing unit 30.

In the embodiment, the import unit 60 obtains the TV shows to be imported under the home broadcasting mode according to the frequencies of each TV show appearing in the favorite TV show lists associated with the identified registered users. In an alternative embodiment, as the favorite TV show lists include broadcasting priorities of TV shows, the import unit 60 obtains the TV shows to be imported under the home broadcasting mode by calculating a weightage of each TV show in the favorite TV show lists associated with the identities of registered users according to frequencies and broadcasting priorities in the favorite TV show lists. In the embodiment, when the number of the TV show to be imported is one, the import unit 60 imports the TV show on the screen 11. When the number of the TV shows to be imported is more than one, the import unit 60 imports a TV show list containing those TV shows on the screen 11, when a user selects a TV show from the TV show list, the import unit 60 imports the selected TV show on the screen 11.

FIG. 3 shows a flowchart of a method for broadcasting TV shows on the smart TV 100. The smart TV 100 includes a body 10, a storage unit 20, a facial image capturing unit 30, an identification unit 40, a control unit 50 and an import unit 60. The storage unit 20 stores facial images of registered users of the smart TV 100 and a mapping relationship between a number of favorite TV show lists and a number of accounts of registered users. The method includes the following steps, each of which is related to the various components contained in the smart TV 100.

In step S301, the facial image capturing unit 30 captures the facial images in front of the facial image capturing unit 30.

In the embodiment, the facial image capturing unit 30 captures the facial image after the smart TV 100 completes the initialization of the system of the smart TV 100 and before a registered user logins his account on the smart TV 100. In another embodiment, the facial image capturing unit 30 captures the facial image when the smart TV 100 receives a command to switch between user accounts.

In step S302, the identification unit 40 identifies whether the facial images captured by the facial image capturing unit 30 contain one or more facial images of the registered users of the smart TV 100, if yes, the process goes to step S203, if no, the control unit 50 controls the smart TV 100 to be under a normal broadcasting mode, and then the process ends.

In step S303, the identification unit 40 identifies the number of the registered users contained in the captured facial images.

In step S304, the control unit 50 controls the smart TV 100 to enter a broadcasting mode according to the number of the identified registered users.

In the embodiment, the broadcasting mode of the smart TV 100 further includes a personal broadcasting mode and a home broadcasting mode. The control unit 50 controls the smart TV 100 to enter the personal broadcasting mode, when the identification unit 40 identifies only one registered user. When more than one registered user is identified by the identification unit 40, the control unit 50 controls the smart TV 100 to enter the home broadcasting mode.

In step S305, the import unit 60 imports TV shows associated with the broadcasting mode of the smart TV 100 and the favorite TV show list(s) corresponding to the identified registered user(s).

In the embodiment, When the smart TV 100 enters the personal broadcasting mode, the import unit 60 imports TV shows preferred by the identified user. When the smart TV 100 enters the home broadcasting mode, the import unit 60 imports TV shows preferred by the identified users.

In the embodiment, the import unit 60 obtains the TV shows to be imported under the home broadcasting mode according to the frequencies of each TV show appearing in the favorite TV show lists associated with the identified registered users. In an alternative embodiment, the import unit 60 obtains the TV shows to be imported under the home broadcasting mode by calculating the weightage of each TV show in the favorite TV show lists associated with the identities of registered users according to frequencies and broadcasting priorities appearing in the favorite TV show lists.

The smart TV 100 provided by the present disclosure includes the facial image capturing unit 30 and the identification unit 40. The facial image capturing unit 30 captures the facial image in front of the body 10 and the identification unit 40 identifies the number of the registered users of the smart TV 100 whose images are contained in the captured facial images. The smart TV 100 further includes the control unit 50. The control unit 50 controls the smart TV 100 to enter a broadcasting mode according to the number of the registered users and broadcast TV shows associated with the broadcasting mode. The method for broadcasting TV shows on the smart TV allows the users access to accounts without using traditional manually input passwords, which saves time for users, and is much more convenient for the users.

Although the present disclosure has been described in considerable detail with reference to certain preferred embodiments thereof, the disclosure is not for limiting the scope of the disclosure. Persons having ordinary skill in the art may make various modifications and changes without departing from the scope and spirit of the disclosure. Therefore, the scope of the appended claims should not be limited to the description of the preferred embodiments described above.

What is claimed is:

1. A smart TV, comprising:
a body;
a facial image capturing unit, configured to capture one or more facial images in front of the facial image capture unit;
a storage unit storing a plurality of facial images of registered users of the smart TV and a mapping relationship between a plurality of favorite TV show lists and a plurality of accounts of registered users, each favorite TV show list for listing favorite TV shows of the corresponding registered user;
an identification unit, configured to identify whether the one or more facial images captured by the facial images capturing unit contains one or more facial images of the registered users of the smart TV and the number of identified registered users contained in the captured facial images;
a control unit, configured to control the smart TV to enter a broadcasting mode according to the number of the identified registered users;
an import unit, configured to import TV shows associated with the broadcasting mode of the smart TV and the favorite TV show lists corresponding to the identified registered users.

2. The smart TV as described in claim 1, wherein the smart TV has a personal broadcasting mode and a home broadcasting mode.

3. The smart TV as described in claim 2, wherein the control unit controls the smart TV to enter the personal broadcasting mode when the number of the identified registered users is one.

4. The smart TV as described in claim 3, wherein the import unit imports TV shows preferred by the identified registered user according to the favorite TV show list of the identified registered user.

5. The smart TV as described in claim 2, wherein the control unit controls the smart TV to enter the home broadcasting mode when the number of the identified registered user is more than one.

6. The smart TV as described in claim 5, wherein the import unit imports TV shows preferred by the identified registered users according to the favorite TV show lists of the identified registered users.

7. The smart TV as described in claim 6, wherein the import unit obtains the TV show to be imported under the home broadcasting mode according to frequencies of each TV show appearing in the favorite TV show lists associated with the identified registered users.

8. The smart TV as described in claim 6, wherein each favorite TV show list further labels a broadcasting priority of each favorite TV show contained in the favorite TV show list.

9. The smart TV as described in claim 8, wherein the import unit obtains the TV shows to be imported under the home broadcasting mode by calculating a weightage of each TV show contained in the favorite TV show lists associated with the identities of registered users according to frequencies and broadcasting priorities appearing in the favorite TV show lists.

10. The smart TV as described in claim 1, wherein the facial image capturing unit captures the facial image after the smart TV completes the initialization of the system of the smart TV and before a registered user logins his account on the smart TV.

11. The smart TV as described in claim 1, wherein the facial image capturing unit captures the facial image when the smart TV receives a command to switch between user accounts.

12. The smart TV as described in claim 1, wherein the facial image capturing unit is equipped on the body.

13. A method for broadcasting TV show for a smart TV, the smart TV comprising a body, a facial image capturing unit and a storage unit storing a plurality of facial images of registered users of the smart TV and a mapping relationship between a number of favorite TV show lists and a plurality of accounts of registered users, each favorite TV show list for listing favorite TV shows of the corresponding registered user; the method comprising:
capturing one or more facial images in front of the facial image capture unit;
identifying whether the captured facial images contain one or more facial images of the registered users of the smart TV;
identifying the number of the identified registered users contained in the captured facial images;
controlling the smart TV to enter a broadcasting mode according to the number of the identified registered users;
importing TV shows associated with the broadcasting mode of the smart TV and the favorite TV show list(s) corresponding to the identified registered user(s).

14. The method as described in claim 13, wherein the broadcasting mode of the smart TV is a personal broadcasting mode or a home broadcasting mode.

15. The method as described in claim 14, wherein the smart TV enters the personal broadcasting mode when the number of the identified registered users is one, and importing the TV shows preferred by the identified registered use according to the favorite TV show list of the identified registered user.

16. The method as described in claim 14, wherein the smart TV enters the home broadcasting mode when the number of the identified registered users is more than one, and importing the TV shows preferred by the identified registered users according to the favorite TV show lists of the identified registered user.

17. The method as described in claim 16, wherein the step “importing the TV shows” comprises obtaining the TV shows to be imported under the home broadcasting mode according to the frequencies of each TV show contained in the favorite TV show lists associated with the identified registered users.

18. The method as described in claim 16, wherein the favorite TV show list further labels a broadcasting priority of each favorite TV show contained in the favorite TV show list.

19. The method as described in claim 18, wherein the step “importing the TV shows” comprises obtaining the TV shows to be imported under the home broadcasting mode by calculating a weightage of each TV show in the favorite TV show lists associated with the identities of registered users according to frequencies and broadcasting priorities in the favorite TV show lists.
